(19) United States
(12) Patent Application Publication
(10) Pub. No.: US 2002/0016169 A1
(43) Pub. Date: Feb. 7, 2002

(54) Method of managing the operation of a mobile terminal of a telecommunications network as a function of the geographical position of the mobile terminal

(75) Inventors: Francis Sykes, Paris (FR); Anne-Marie Hartmann, Carrieres Sur Seine (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 09/891,182

(22) Filed: Jun. 27, 2001

(30) Foreign Application Priority Data
Jun. 30, 2000 (FR) 00 08 494

(51) Int. Cl. H04Q 7/20

(52) U.S. Cl. 455/435; 455/425

(57) ABSTRACT

The network is divided into cells each corresponding to the coverage area of a base station adapted to exchange data with the mobile terminal by radio. The position of the mobile terminal is defined continuously when it is in operation by location data that is a function of at least one base station. The method is of the type in which at least two separate geographical areas and at least one operating feature of the mobile terminal specific to each area are defined. Each area is defined by location data that is a function of a set of base stations including at least one of the base stations contained in the area. The location data of the areas and the operating features specific to those areas are stored in a memory of the mobile terminal. The location data of the mobile terminal is compared to the location data of the areas to deduce in which area the mobile terminal is located. The operating feature specific to an area is applied as soon as the mobile terminal is located in that area.

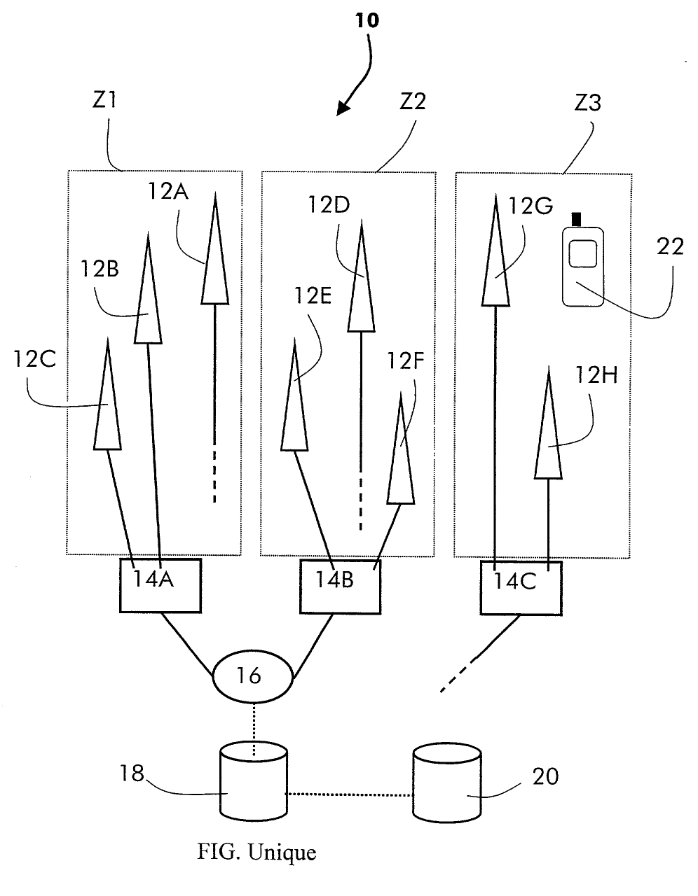

The present invention relates to a method of managing the operation of a mobile terminal of a telecommunications network as a function of the geographical position of the terminal.

### BACKGROUND OF THE INVENTION

A method of managing the operation of a mobile terminal of a telecommunications network as a function of the geographical position of the terminal is known in the art, in particular from the document U.S. Pat. No. 5,568,153, in which the network is divided into geographical cells each corresponding to the coverage area of a base station adapted to exchange data by radio with the mobile terminal when it is in operation, the position of the mobile terminal when it is in operation being defined continuously by location data that is a function of at least one base station of the cell in which the terminal is located. In this method at least two separate geographical areas and at least one operating feature of the terminal specific to each area are defined.

A Global System for Mobile communications (GSM) cellular telecommunications network conventionally includes a base station subsystem (BSS) and a network subsystem (NSS).

The base station subsystem is adapted to manage exchange of data with the mobile terminals by radio and to this end includes base transceiver stations (BTS) and base station controllers (BSC).

The network subsystem is adapted to manage calls, allowing for the mobility of the terminals, and to this end includes databases and cellular network mobile services switching centers (MSC).

The databases essentially comprise a home location register (HLR), containing in particular data relating to the contracts of users (the services provided under the contract, international call authorization, etc.) and coarse user location data, and a visitor location register (VLR), containing in particular data relating to users present in a particular area and more precise user location data.

The method described in the document U.S. Pat. No. 5,568,153 defines two geographical areas, namely a home area and an exterior area complementary to the home area. The home area is defined by the coordinates of a home location at the center of the home area. The coordinates of the home location are stored in a unit of the network subsystem, namely the HLR database.

In the document U.S. Pat. No. 5,568,153 the operating features of a terminal specific to each area are services specific to that area, such as the application of specific charges, defined by parameters stored in the HLR database. In the method described in the document U.S. Pat. No. 5,568,153, a service is performed only after it has been invoked. Accordingly, when a service specific to an area is invoked, the method determines if the mobile terminal is in that area and then, if necessary, adjusts the service parameters accordingly.

A drawback of the method described in the document U.S. Pat. No. 5,568,153 is that the location data for the home and complementary areas increases the load on the telecommunications network, and in particular the load on the HLR database of the network subsystem in which the location data is stored. Also, a service specific to an area is activated only when it is explicitly invoked, which increases the power consumption of the terminal, which must send signals to the network, and monopolizes radio resources.

### OBJECTS AND SUMMARY OF THE INVENTION

One object of the invention is to propose a method of the above type in which storing location data of the various geographical areas in memory does not add to the load on the telecommunications network because an operating feature of the terminal specific to an area is executed automatically, as soon as the terminal enters that area.

To this end, the invention provides a method of the type described in the document U.S. Pat. No. 5,568,153, wherein:

each area is geographically defined by location data that is a function of a set of base stations including at least one of the base stations contained in the area,

location data of the areas and operating features specific to the areas are stored in a memory of the mobile terminal,

location data of the mobile terminal is compared to the location data of the areas to deduce in which area the mobile terminal is located, and

the operating feature specific to an area is applied as soon as the mobile terminal is located in that area.

According to other features of the method:

at least one area is defined by location data that is a function of a reference base station and at least one other base station in the environment of the reference base station;

the location data of the areas and the operating features specific to the areas are entered directly via the mobile terminal or via data entry means connected to the terminal by a cable;

the location data of the areas and the operating features specific to the areas are entered via data entry means separate from the mobile terminal and the data entered is sent to the mobile terminal electromagnetically;

the data entered is sent to the mobile terminal (22) by radio via the telecommunications network (10);

the operating features of the mobile terminal concern adjusting an operating parameter of the mobile terminal as a function of its location, such as activating or deactivating a ringer or call forwarding, adjusting the local time, etc., and/or triggering an event, such as triggering a warning ringer, as a function of a change of location of the mobile terminal;

there is at least one area containing more than one base station;

there is at least one area associated with a plurality of operating features of the mobile terminal specific to that area;

there are more than two areas associated with a plurality of operating features of the mobile terminal specific to those areas;

reference data and operating features of the mobile terminal corresponding to that reference data are also stored in a memory of the mobile terminal, data sent to the mobile terminal by the base station of the cell in which the mobile terminal is located is compared with the stored reference data, and the operating feature of the mobile terminal corresponding to the stored reference data is applied as soon as that reference data matches the data sent by the base station of the cell in which the mobile terminal is located; and

one operating feature of the mobile terminal concerns prohibition of modification by a user of data stored in the memory of the mobile terminal.

### BRIEF DESCRIPTION OF THE DRAWING

The invention will be better understood after reading the following description, which is given by way of example only and with reference to the accompanying drawing, in which the single FIGURE is a diagram showing a telecommunications network which uses a method according to the invention.

### MORE DETAILED DESCRIPTION

The single FIGURE shows a conventional cellular telecommunications network 10, for example a GSM network.

The telecommunications network 10 includes a base station subsystem including base transceiver stations (BTS) 12A to 12H connected to base station controllers (BSC) 14A to 14C in a star architecture, for example.

The telecommunications network 10 also includes a network subsystem including cellular network mobile services switching centers (MSC) 16. Each of the cellular network mobile services switching centers is connected to a database constituting a visitor location register (VLR) 18 exchanging data with at least one database constituting a home location register (HLR) 20.

The single FIGURE also shows a mobile terminal 22 whose operation is managed by a method in accordance with the invention as a function of the geographical position of the terminal 22. The mobile terminal 22 is adapted to exchange data with the base transceiver stations 12A to 12H by radio. This is known in the art.

The telecommunications network 10 is divided into geographical cells each substantially corresponding to the coverage area of a base transceiver station 12A to 12H. Note that some points in a cell can be common to more than one cell, especially points near the boundaries of the cell.

When it is in operation, the mobile terminal 22 continuously identifies the surrounding base transceiver stations 12A to 12H (and therefore the corresponding surrounding cells). This is standard practice in the operation of a cellular network. It is also standard practice for the position of the mobile terminal 22 to be defined continuously when the terminal is in operation by location data that is a function of at least one of the base transceiver stations 12A to 12H, in particular the base transceiver station 12A to 12H of the cell in which the mobile terminal 22 is located.

Note, however, that the precise position of the mobile terminal is usually not communicated to the network. This is because the network operator usually defines mobile terminal location areas that are specific to that operator. Each location area is identified by a set of base transceiver stations transmitting an identical location code. If the mobile terminal changes location area, the network is informed of this by an exchange of information between the network and the mobile terminal instigated by the change to the location code received by the terminal. The operator can therefore locate the mobile terminal with an accuracy that depends on the size of the location areas, i.e. on the number of base transceiver stations that they contain.

To manage the operation of the mobile terminal 22 as a function of its position, at least two separate geographical areas and at least one operating feature of the mobile terminal 22 specific to each area are defined. Accordingly, the single FIGURE shows three geographical areas Z1, Z2 and Z3 in each of which there are several base transceiver stations 12A to 12H.

In the method of the invention, each area Z1 to Z3 is geographically defined by location data that is a function of a set of base transceiver stations containing at least one of the base transceiver stations 12A to 12H in the areas Z1 to Z3.

The location data of the areas Z1 to Z3 and the operating features specific to those areas Z1 to Z3 are then stored in a memory of the mobile terminal 22, for example in the form of a table like that below:

| | GEOGRAPHICAL DEFINITION | |
|---|---|---|
| AREA | OF AREA | OPERATING FEATURES |
| Z1 | As a function of 12A, 12B, | wake-up ringer activated |
| | 12C | etc. |
| Z2 | As a function of 12D, 12E, | forwarding to voicemail |
| | 12F | service etc. |
| Z3 | As a function of 12G, 12H | message display |
| | | etc. |

The areas Z1 to Z3 and the operating features specific to those areas Z1 to Z3 are preferably defined by parameters entered by the user. The parameters can be entered via a conventional interface, for example a keypad and a display of the mobile terminal 22 or a computer temporarily connected to the mobile terminal 22 by a cable. The parameters can instead be entered from an Internet browser using a data transmission mode suitable for mobile telephones, such as the Wireless Application Protocol (WAP). Accordingly, the network operator (or a service provider) can recover the parameters that the user has entered on an appropriate Internet site, if necessary convert them into location data relating to the base transceiver stations (12A to 12H) that can be used directly by an algorithm programmed in the mobile terminal 22, and then send the data to the mobile terminal of that user, for example if the network detects a change of location area.

The location data of the areas Z1 to Z3 and the operating features specific to those areas Z1 to Z3 can therefore be entered directly via the mobile terminal 22 or via data entry means connected to the terminal 22 by a cable. The location data of the areas Z1 to Z3 and the operating features specific to those areas Z1 to Z3 can instead be entered via means separate from the mobile terminal 22. In this case, the data entered is sent to the mobile terminal 22 electromagnetically, for example by radio via the telecommunications network 10.

Note that the invention enables both the user and the network operator to modify the data stored in the mobile terminal.

For example, the user can define a “home” area, a “work” area, an “appointments” area, a “public place” area, etc. and operating profiles of the mobile terminal 22 specific to those areas. An area can in particular relate to personal and permanent data, as in the case of the “home” or “work” area, for example, personal and temporary data, as in the case of the “appointments” area, for example, or impersonal permanent or temporary data, as in the case of the “public place” area, for example.

The operating features of the mobile terminal 22 can relate to the adjustment of an operating parameter of the mobile terminal 22 as a function of its location, such as activation or deactivation of a ringer or call forwarding, adjustment of the local time, etc.

The operating features of the mobile terminal 22 can equally relate to triggering an event, such as triggering a warning ringer, as a function of a change of location of the mobile terminal.

When the mobile terminal 22 is in operation, its position is continuously defined by location data that is a function of at least one of the base transceiver stations 12A to 12H, in particular the base transceiver station 12A to 12H of the cell in which the mobile terminal 22 is located. The location data for the mobile terminal 22 is usually supplied by the telecommunications network 10. However, the location of the mobile terminal 22 can if necessary be provided by a system external to the telecommunications network and defining the position of the mobile terminal 22 by means of location data expressed independently of the base transceiver stations, for example by coordinates like those supplied by the Global Positioning System (GPS). In this case, the location data for the mobile terminal 22 expressed independently of the base transceiver stations is automatically converted by an interface of the telecommunications network 10 into location data that is a function of at least one of the base stations 12A to 12H.

The location data for the mobile terminal 22 expressed as a function of at least one of the base transceiver stations 12A to 12H is continuously compared in the terminal to the location data of the areas Z1 to Z3 stored in the mobile terminal 22 to deduce in which of the areas Z1 to Z3 the terminal 22 is located.

Note that, in conventional systems, when the mobile terminal 22 is in a cell it can exchange data with the base transceiver station of that cell, which is referred to as the “reference station”, and with other surrounding base transceiver stations, which are referred to as “visible stations”.

Accordingly, in another embodiment of the invention, not shown, it is possible to define an area Z1 to Z3 relatively precisely by location data that is a function of a reference base station (12A to 12H) and, if necessary, at least one other base transceiver station located in the environment of the reference base transceiver station.

For example, an area Zn can be defined as the area whose reference base transceiver station is the station 12n and whose visible stations are the stations 12n+1, 12n+2 and 12n+3, the field level (or any other parameter, such as the phase advance) of the station 12n+1 being at least twice that of the station 12n+3.

An area Zn defined in this way can be smaller than, the same size as, or larger than the cell containing the reference base transceiver station.

As soon as the area Z1 to Z3 in which the mobile terminal 22 is located has been identified (in this example the mobile terminal 22 is in the area Z3), the operating feature specific to that area Z1 to Z3 is automatically applied.

The mobile terminal 22 can operate in accordance with the method of the invention as in the following scenario, for example.

A user leaves the “home” area and, traveling to work, reaches the “work” area. The operating features specific to the “work” area are activated as soon as the user carrying the mobile terminal 22 enters that area. One such feature automatically forwards personal calls to a voicemail service, for example. When traveling through the “appointments” area on the way home, the user is automatically advised by a ringer (the operating feature specific to the “appointments” area) to enter a store to make some purchases, for example.

Note that the method according to the invention can define more than two areas, each of which can be associated with several operating features of the mobile terminal 22. Also, each area generally contains more than one base transceiver station 12A to 12H, but if necessary it is possible to limit an area to a single base transceiver station 12A to 12H, and the area can be smaller than a cell including that base transceiver station, as previously mentioned.

One particular advantage of the invention is that it stores location data for the various geographical areas in a memory of the mobile terminal, which avoids loading the databases of the telecommunications network.

Also, an operating feature of the mobile terminal specific to an area is activated automatically, as soon as the terminal reaches that area.

Also, the invention triggers an event at the mobile terminal as a function of a spatial parameter (the location of the mobile terminal) and not merely as a function of a time parameter, as is generally the case in the prior art. The location and dimensions of a geographical area can be varied.

Also, it is possible to make an operating feature of the mobile terminal conditional on reception by the mobile terminal of appropriate data broadcast by the base transceiver station of the cell in which the terminal is located, i.e. transmitted continuously to all mobile terminals in the environment of that base transceiver station.

To this end, reference data and operating features of the mobile terminal 22 corresponding to that reference data are stored in a memory of the mobile terminal 22.

When the mobile terminal 22 is in operation, data transmitted to the mobile terminal by the base transceiver station 12A to 12H of the cell in which the mobile terminal is located is compared in the terminal to the stored reference data.

Any operating feature of the mobile terminal (22) corresponding to stored reference data is applied as soon as that reference data corresponds to that transmitted by the base transceiver station (12A to 12H) of the cell in which the mobile terminal (22) is located.

For example, the reference data can identify a particular space, such as an aircraft or a concert hall, for which the corresponding operating feature is “turn off mobile”.

Accordingly, when a user enters a particular space, such as an aircraft or a concert hall, the base transceiver station associated with that space transmits specific data to the mobile terminal. That data is compared in the terminal with stored reference data in order to turn off the mobile terminal in accordance with the stored operating feature.

Note that one operating feature of the mobile terminal 22 can relate to prohibition of modification by a user of data stored in the memory of the mobile terminal 22.

1. A method of managing the operation of a mobile terminal of a telecommunications network as a function of the geographical position of that mobile terminal,
the network being divided into geographical cells each corresponding to the coverage area of a base station adapted to exchange data with the mobile terminal by radio, the position of the mobile terminal being defined continuously when it is in operation by location data that is a function of at least one base station,
the method being of the type in which at least two separate geographical areas and at least one operating feature of the mobile terminal specific to each area are defined,
wherein
each area is geographically defined by location data that is a function of a set of base stations including at least one of the base stations contained in the area,
location data of the areas and operating features specific to the areas are stored in a memory of the mobile terminal,
location data of the mobile terminal is compared to the location data of the areas to deduce in which area the mobile terminal is located, and
the operating feature specific to an area is applied as soon as the mobile terminal is located in that area.

2. A method according to claim 1, wherein at least one area is defined by location data that is a function of a reference base station and at least one other base station in the environment of the reference base station.

3. A method according to claim 1, wherein the location data of the areas and the operating features specific to the areas are entered directly via the mobile terminal or via data entry means connected to the terminal by a cable.

4. A method according to claim 1, wherein the location data of the areas and the operating features specific to the areas are entered via data entry means separate from the mobile terminal and the data entered is sent to the mobile terminal electromagnetically.

5. A method according to claim 4, wherein the data entered is sent to the mobile terminal by radio via the telecommunications network.

6. A method according to claim 1, wherein the operating features of the mobile terminal concern:
adjusting an operating parameter of the mobile terminal as a function of its location, such as activating or deactivating a ringer or call forwarding, adjusting the local time, etc., and/or
triggering an event, such as triggering a warning ringer, as a function of a change of location of the mobile terminal.

7. A method according to claim 1, wherein there is at least one area containing more than one base station.

8. A method according to claim 1, wherein there is at least one area associated with a plurality of operating features of the mobile terminal specific to that area.

9. A method according to claim 1, wherein there are more than two areas associated with a plurality of operating features of the mobile terminal specific to those areas.

10. A method according to claim 1, wherein
reference data and operating features of the mobile terminal corresponding to that reference data are also stored in a memory of the mobile terminal,
data sent to the mobile terminal by the base station of the cell in which the mobile terminal is located is compared with the stored reference data, and
the operating feature of the mobile terminal corresponding to the stored reference data is applied as soon as that reference data matches the data sent by the base station of the cell in which the mobile terminal is located.

11. A method according to claim 1, wherein one operating feature of the mobile terminal concerns prohibition of modification by a user of data stored in the memory of the mobile terminal.
